(19) United States
(12) Patent Application Publication
(10) Pub. No.: US 2012/0103918 A1
(43) Pub. Date: May 3, 2012

(54) Chlorinator For Portable Spas

(76) Inventor: Michael McCague, Escondido, CA (US)

(21) Appl. No.: 13/335,027

(22) Filed: Dec. 22, 2011

Related U.S. Application Data
(62) Division of application No. 12/257,861, filed on Oct. 24, 2008, now abandoned.

(51) Int. Cl. C02F 1/72; C02F 103/42

(52) U.S. Cl. 210/748.17

(57) ABSTRACT

An oxidizer generating apparatus having a housing with a fluid inlet at a first end, the inlet leading to a chamber, and a lid attachable to a second end of the housing for closing the chamber. First and second pairs of electrodes are attached to the lid so as to suspend them within the chamber in position to generate chlorine and/or other oxidants from fluid pumped through the housing.

### RELATED APPLICATION

This application is a divisional of and claims priority to U.S. Utility patent application Ser. No. 12/257,861, entitled “CHLORINATOR FOR PORTABLE SPAS,” filed on Oct. 24, 2008. The contents of that application are incorporated expressly by reference herein, as if fully set forth and full Paris Convention Priority is hereby expressly claimed.

### FIELD OF INVENTION

This disclosure relates to water purification particularly with respect to water containing vessels such as spas, hot tubs, whirlpools, pools and the like and to a chlorinator or oxidizer generator suitable for such purpose.

### RELATED ART

Portable spas have become quite popular as a result of their ease of use and multiplicity of features such as varied jet and seating configurations. Maintaining appropriate water chemistry and sanitation is of course important to enhancing the spa user experience.

### SUMMARY

The following is a summary of various features, aspects, and advantages realizable according to various illustrative embodiments of the invention. It is provided as an introduction to assist those skilled in the art to more rapidly assimilate the detailed discussion which ensues and does not and is not intended in any way to limit the scope of the claims which are appended hereto in order to particularly point out the invention.

An illustrative embodiment of a portable spa chlorinator includes a housing having a fluid inlet at a first end, which leads to a chamber within the housing. A lid is attachable to a second end of the housing to close the chamber. First and second pairs of electrodes are attached to the lid so as to be suspended within the chamber when the lid is attached to the housing. When an appropriate voltage is applied, the electrodes interact with the fluid pumped through the chamber to generate various oxidizing agents.

In one embodiment, each electrode of the first and second pairs comprises a doped diamond surface, wherein the dopant may be, for example, boron. In one illustrative embodiment, the doped diamond surface resides on a substrate, while in another the doped diamond surface comprises the surface of a whole diamond electrode. In the former illustrative embodiment, the substrate may be selected from one of the group including titanium, niobium, silicon, platinum, or stainless steel. The electrodes may be solid metal plates or a mesh, the latter providing increased surface area.

### BRIEF DESCRIPTION OF THE DRAWINGS

FIG. 1 is a perspective view of a chlorinator according to an illustrative embodiment.

FIG. 2 is an exploded perspective view of the chlorinator of FIG. 1.

FIG. 3 is an exploded perspective view of an electrode assembly illustrated in FIG. 2.

FIG. 4 is a schematic side view of a diamond doped electrode according to an illustrative embodiment.

FIG. 5. is a side schematic view of a chlorinator installed in the fluid circulation line of a portable spa.

FIG. 6 is a partial perspective view of an illustrative embodiment of a lid and mesh electrode assembly.

### DETAILED DESCRIPTION

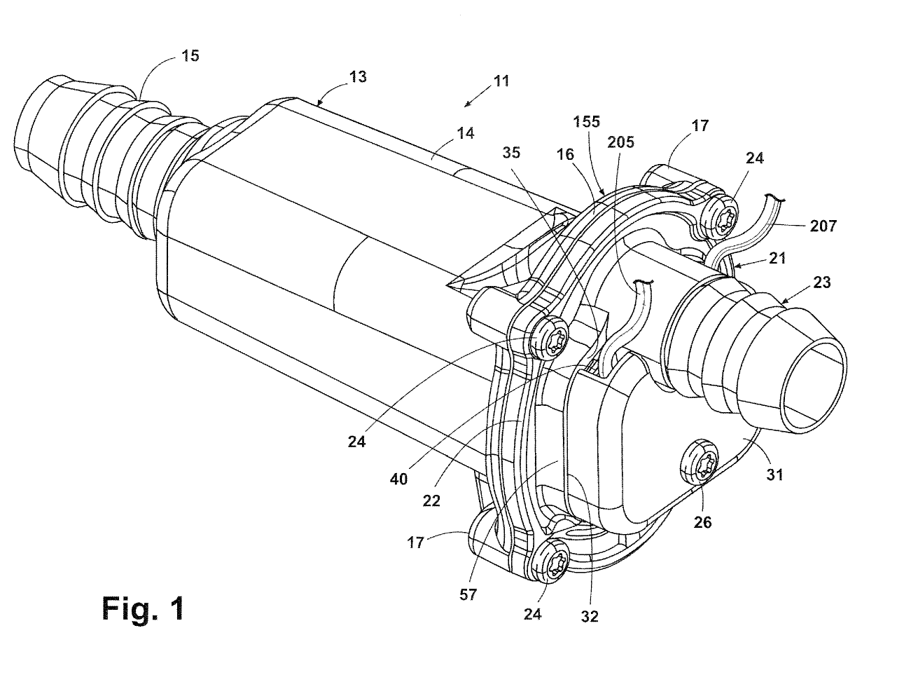

A chlorinator 11 according to a illustrative embodiment is shown in FIGS. 1-3. The chlorinator 11 includes a housing 13, a lid 21, and a cap 31. The housing 13 is preferably a unitarily molded polyvinyl chloride (PVC) part with an integrally molded, barbed fluid outlet 15 at one end and an integrally molded flange 155 at the opposite end. In the illustrative embodiment, the housing 13 has a generally rectangular cross-section with rounded corners, e.g. 14, arcing through ninety degrees, and is adapted to be plumbed into the circulation line of a portable spa.

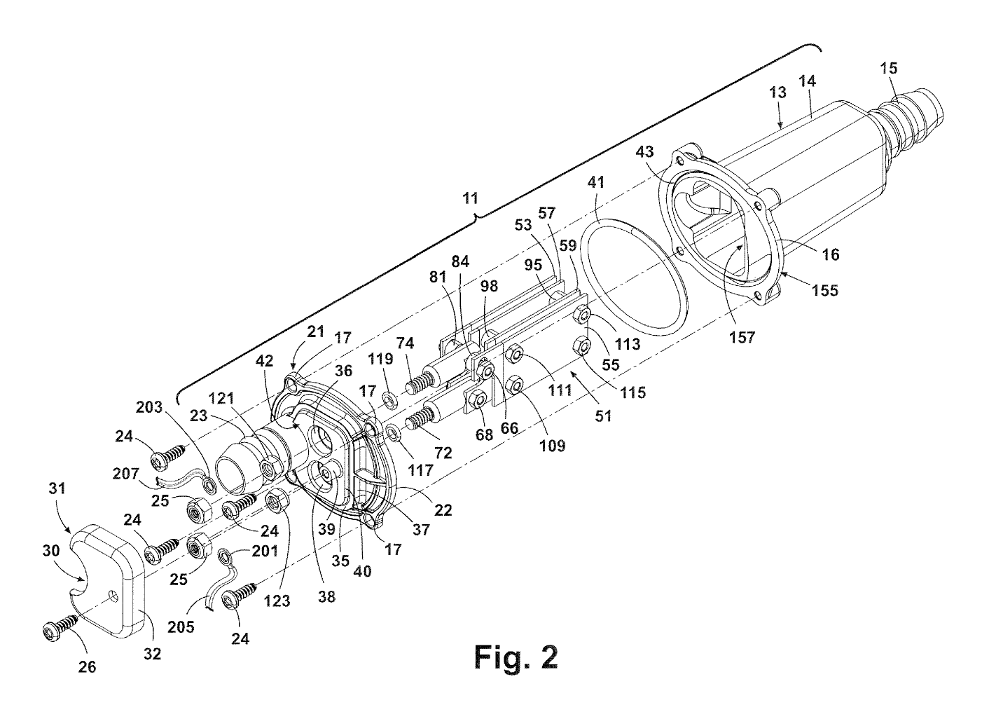

The lid 21 is also preferably a unitarily molded PVC part having a rim 22 whose contour conforms in shape to that of the rim 16 of the housing flange 155. Four self-threading screws 24 attach the lid 21 to the flange 155. An integrally molded, barbed fluid inlet 23 protrudes from the base 24 of the lid 21 and provides a fluid inlet to the housing 13. As seen in FIG. 2, an o-ring 41 is inserted in a circular receiving channel 43 in the housing 13 to provide a watertight seal between the housing 13 and the lid 21.

The cap 31 is also preferably a unitarily molded PVC part and is attached to the lid 21 by a screw 26. The edge 32 of the cap 31 fits flush against a mounting surface 35 of a raised (mesa) area 37 of the lid 21 and against an axially projecting perimeter edge or lip 40 of a second raised area 41. The cap 31 is fastened into place against surface 35 by the screw 26, which threads into a raised boss 39 portion of the lid 21. Electrical leads 205, 207 enter through apertures at each side of the cap 31.

As noted above, in the illustrative embodiment, the housing 13, lid 21 and caps 31 are unitarily molded plastic parts. It should be understood that, in other embodiments, these parts could be fabricated as an assembly of sub-components. Additionally, such parts could be fabricated of materials other than PVC, for example, such as ABS, Luran, Teflon, PTFE or Kynar.

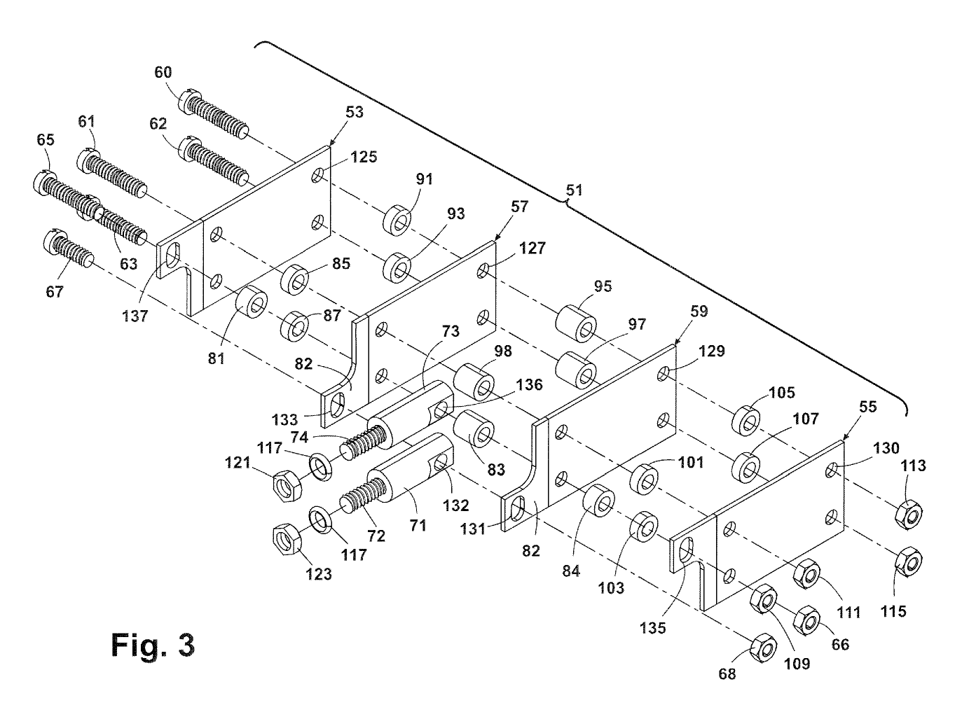

FIGS. 2 and 3 depict an electrode or cell assembly 51. The assembly 51 includes a first pair of electrodes 53, 55 and a second pair of electrodes 57, 59. Each of the four electrodes 53, 55, 57, 59 lie parallel to one another in respective horizontal planes in the illustrative embodiment.

As shown in FIGS. 2 and 3, the two inner electrodes 57, 59 and two outer electrodes 53, 55 are held in position by four bolts 60, 61, 62, 63, which pass through respective sets of co-linear holes, one set being, for example, the four holes 125, 127, 129, 130. The four bolts 60, 61, 62, 63 further pass through suitable spacers, respectively 91, 95, 105; 85, 98, 101; 93, 97, 107; and 87, 83, 103 and thread into suitable respective nuts 113, 111, 115, 109. The bolts 60, 61, 62, 63 and their associated spacers and nuts are preferably fabricated of a suitable plastic, such as, for example, PVDF (Kynar).

The two inner electrodes 57, 59 are connected to a voltage of a first polarity by a first supply electrode 71. The first supply electrode 71 is attached to the two inner plates 57, 59 by a bolt 67. The bolt 67 passes through respective oblong apertures 131, 133 in L-shaped mounting sections 82 of the electrodes 57, 59, then through a hole 132 in the electrode 71, and then threads into a nut 68.

The two outer electrodes 53, 55 are connected to a source of voltage opposite in polarity to that applied to the inner electrodes 57, 59. That voltage is supplied by a second supply electrode 73, which is attached to the outer electrodes 57, 59 by a bolt 65. The bolt 65 passes through oblong apertures 135, 137 in L-shaped mounting sections 82 of the electrodes 53, 55, then through a hole 136 in the second supply electrode 73 and then threads into a nut 109. The bolts 65, 67 and supply electrodes 71, 73 are fabricated of conductive material such as, for example, titanium or platinum.

The projecting shafts 72, 74 of the respective supply electrodes 71, 73 pass through respective holes in the lid 21 leading to respective wells 38, 36 and are fastened to the lid 21 by respective locking nuts 121, 123 and sealed against respective O-rings 117, 119, which may be, for example, viton o-rings. The o-rings 117, 119 provide a watertight seal and, together with o-ring 41 insure that fluid does not escape or leak out of the housing 13.

Respective locking nuts 25 hold the ring terminals 201, 203 of the respective supply leads 205, 207 to the supply electrodes 71, 73. Attachment of the cap 31 then covers the wells 36, 38, the electrical leads 205, 207 and the supply electrode shafts 72, 74.

Thus, the electrode assembly 51 is attached to the lid 21 and is suspended within the housing 13 when the lid 21 is attached to the housing by the screws 24. The interior of the housing 13 forms a chamber 157 wherein hydroxyl radicals are generated when power is supplied to the electrodes 71, 73 via the leads 205, 207.

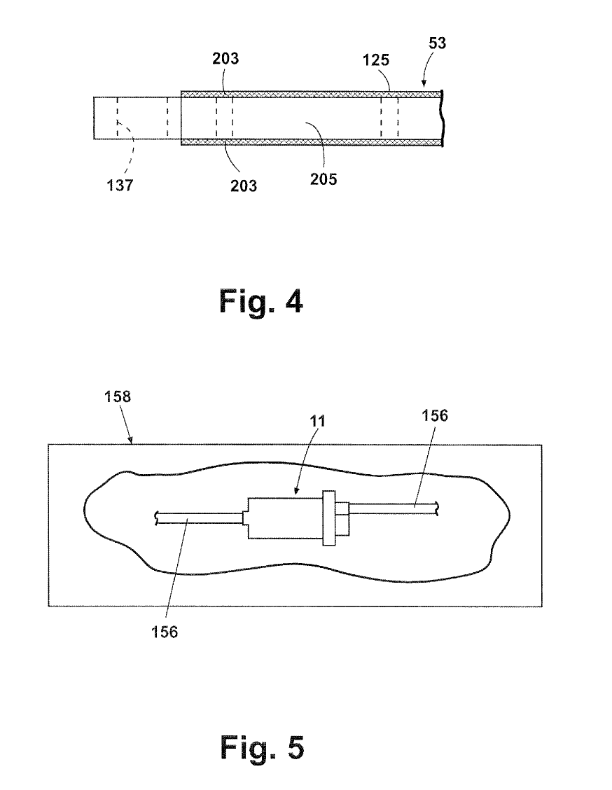

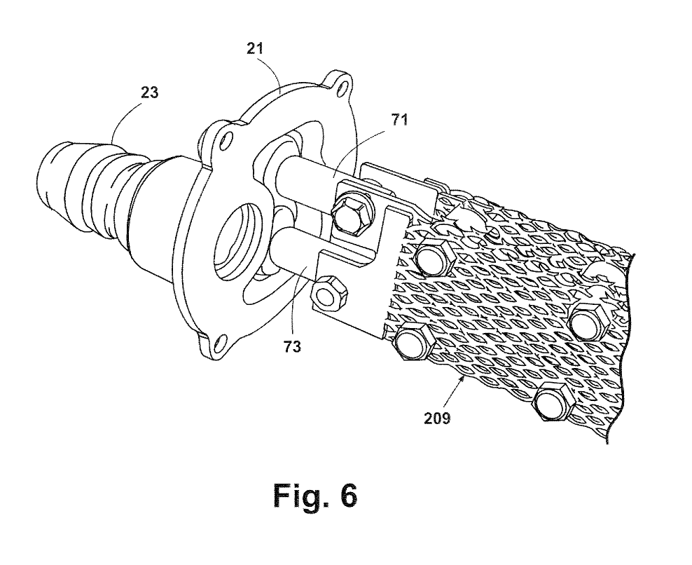

In one embodiment, the electrodes 53, 55, 57, 59 are rectangular in shape and each comprise a boron doped synthetic diamond electrode tailored to flow rate. As illustrated in FIG. 4, such electrodes may be formed, for example, by chemical vapor deposition (CVD) of a very thin coating 203 of boron or nitrogen doped diamond onto a niobium substrate 205. Such electrodes may be fabricated, for example, by Adamant, Chauxde-Fords, Switzerland. Other substrate materials may be used such as titanium, silicon, platinum or stainless steel. Embodiments may also be constructed of self-supporting diamond without using a substrate, such as may be obtained, for example, from Advanced Oxidation, Cornwall, U.K. In various embodiments, the substrates may either be solid plates or mesh, the latter providing increased surface area. FIG. 6 illustrates an embodiment employing mesh electrodes 209.

In operation of illustrative embodiments in an illustrative portable spa environment, a chlorinator 11 is installed in the circulation line 156 of a portable spa 158 as shown in FIG. 5. A constant current mode of operation of the device 11 may be employed. In such case, a selected current flow through each electrode pair 57, 59; 53, 55 in the range of 1-5 amps, for example, 2 amps, may be used with a floating voltage across each electrode pair of 5-24 volts. In such embodiments, flow rates through the cell 11 may range from ½ gallon to 5 gallons per minute with a salt (NaCl) level in the spa water of from 500 ppm to 3500 ppm (target 1,000 to 2,000 ppm). Electronically, a constant current AC/DC transformer supplying 1 to 4.5 amps at 5 to 24 volts D.C. may be used along with a microcontroller to control activation of the cell 11.

In such embodiments, hydroxyl radicals are generated directly off the electrode plates 53, 55, 57, 59. The hydroxyl radicals then oxidize organic waste in the process water or react with water and dissolved salts to produce various oxidizers. These include but are not limited to, ozone (O3), hydrogen peroxide (H2O2), sodium hypochlorite (NaHOCl/OCl), chlorine dioxide (ClO2), sodium persulfates (NaHSO5) and sodium percarbonate (Na₂CO₃). This broad spectrum of oxidizers is capable of neutralizing organic and other contaminants which may be present.

The design of the housing 13 is preferably such as to provide adequate mixing and turbulence of the process stream and the generated hydroxyl radicals. Flow through the cell 11 is optimized to allow for the self cleaning of the cell generated by polarity reversing and sloughing of the formed scale layers. Vapor lock is prevented in the cell 11 though either maintaining flow when the cell 11 is mounted horizontally with inlet 23 located on the top as shown in FIG. 1 or by mounting the cell 11 vertically with water entering the inlet 23 from the bottom.

A chlorine generator system according to an illustrative embodiment may operate in an open-loop mode using scheduled and timed generation of chlorine. The length and interval of daily generation is typically a function of the spa size, bather load, and water salinity. In such a system, the cell 11 may produce a constant stream of 0.1 to 0.60 ppm (parts per million) chlorine in a 4 gpm flow (2 Amp & 1000 to 2000 ppm salt). To maintain the chlorine level in the water, the cell 11 must operate longer for a large spa than for a small spa. Additionally the cell 11 must run longer with a higher expected bather load. The salt level has a strong direct relationship to the quantity of chlorine produced.

In an illustrative open loop system the user inputs three variables to the system at start-up. The first is the spa size (SPA). A size code may be used (e.g. 1-8). The anticipated use level, (USE) (1-5) is the second variable. Use level “(1)” corresponds to minimal use and vacation mode. A higher level should be entered if more bathing is expected. The user preferably adjusts the use level over the course of use. The third start-up variable input is the water hardness (Hd). This parameter controls the polarity reversal cycle timing used to clean the electrodes.

As an additional input feature, a manual chlorine addition (Add) command may be implemented. This command instructs the system to generate enough chlorine to add 2 ppm to the spa. This chlorine Add temporarily overrides scheduled operation times.

The manual Add command dictates that the system run for a length of time sufficient to add 2 ppm Chlorine. The amount of time needed to bring the water to 2 ppm is highly dependent on the amount of bather load in the water. A standard 24 hour dose or longer may be needed to completely bring the water up. In one implementation of the Add command, the system switches from 2 amps to 4-4.5 amps to rapidly generate chlorine. One run cycle every six hours may be used to maintain uniform around the clock treatment.

In one embodiment, salt is measured each time the unit 11 generates chlorine as well as when requested by the user. The system measures the salt level of the water by means of measuring the voltage across the cell 11. The voltage reading is then compared against allowable limits. The salt concentration is normalized, and displayed on the user interface. A voltage higher than specified returns a low salt error and a voltage less than specified returns a high salt error.

If there is a low salt condition, an error may be sent to the spa controls, triggering a “water care” icon to flash. The unit 11 may be allowed to continue to generate chlorine in this condition. The spa controls or controller will boost available voltage to a regulated limit to automatically compensate for low salt or conductivity situations. If there is a high salt condition, an error will be sent to the spa controls, again triggering the water care icon to flash. In this case, the unit 11 will not generate chlorine until the salt level has been corrected.

To prevent mineral scale on the electrodes 53, 55, 57, 59, polarity reversal may be used. The time period of the reversal is a function of water hardness and is preferably made adjustable to a user input hardness reading. Rapid cycling of the electrodes will cause premature electrode failure. Therefore a dead band in the cycle may be implemented to allow the electrodes to discharge prior to the polarity reversal. The dead band interval may be, for example, a minimum of 20 seconds.

At either initial start-up or at a maintenance event, the spa water should be manually balanced. Once the spa water has been balanced it should be super chlorinated (5 ppm). Super chlorination prepares the system for operation and immediate spa usage by cleaning the spa after a period of nonuse. After super chlorination, salt is added to the water. The spa control system may operate such that the water care icon is blinking to indicate that the salt level is low and/or the unit has not been initialized or programmed. Salt should be added slowly into the filter compartment while all of the jets are operating. The jets should operate an additional 10 minutes after the salt is fully added. An example of a target salt concentration is 1000 ppm. High demand users can add up to 2000 ppm salt, which will lower the hours required to generate chlorine and therefore lower the USE level. A salt level reading is preferably taken every time the unit begins a generation cycle to ensure proper salt levels at start-up and during the time between water changes.

Typical operation of an illustrative system preferably requires a weekly chlorine and water quality check to ensure that the system is working correctly. Although the user is not required to enter the chlorine concentration, the value is needed to determine the use level. Over the course of the first month, the user may determine their Use Level by taking a reading of the water before they enter the spa. If the chorine level is low, e.g., “1” or less, the user will want to increase the use level by one to increase the output. If the user finds that the chlorine level is 5 or higher, the user will want to drop the use level by one and retest in a few days or a week. If the bather load is predictable, the use level may only need occasional adjustments.

If the bather load is sporadic, the user may want to perform a manual addition. In such case, the user may enter the spa control menu and confirm an addition (Add). The addition operation turns the system on immediately and operates the specified amount of time determined to elevate the chlorine level by 2 ppm (this depends on bather load and time and cannot be guaranteed). If the water is overly polluted such that the actual bather load far exceeded the anticipated bather load, a manual dichlor/MPS dose may be used and is compatible with the system.

Typically, the spa will require a monthly manual shock with MPS or dichlor to eliminate any accumulated waste. The oxidizer level should be brought to and held at 5 ppm while all jets configurations and pumps are operated for 30 minutes each. It is important to monitor pH at this time as well to ensure that the water remains balanced.

Over time the water level in spa typically drops from evaporation or splash out. When fresh water is added to the spa, it is important to rebalance the water and monitor the salt concentration. The system may employ a conductivity sensor to determine the amount of salt in the water and whether it is too high or too low. A water care icon may be arranged to blink to indicate that the salt is low and that more salt is needed. Salt should be added in 0.25 lb (100 g) increments to ensure that it is not over dosed.

While the apparatus and method have been described in terms of what are presently considered to be the most practical and preferred embodiments, it is to be understood that the disclosure is not limited to the disclosed embodiments. It is intended to cover various modifications and similar arrangements included within the spirit and scope of the appended claims.

1. A method of purifying water in a spa comprising:
providing an oxidizer generator apparatus for placement in the spa water, the oxidizer generator apparatus comprising a housing and a plurality of spaced apart electrodes positioned within the housing;
converting A.C. power to D.C. power;
employing the D.C. power to cause the oxidizer generator apparatus to generate one or more purifying agents; and
controlling the power supplied to the oxidizer generator apparatus to adjust the amount of purifying agent or agents generated by said oxidizer generator apparatus.

2. The method of claim 1 wherein said D.C. power is applied to said oxidizer generator apparatus in a constant current mode of operation.

3. The method of claim 1 further comprising responding to a “spa size” input to adjust said amount.

4. The method of claim 1 further comprising responding to a spa “use level” input to adjust said amount.

5. The method of claim 1 further comprising responding to a “boost” input to adjust said amount.

6. The method of claim 1 further comprising responding to a water hardness input to adjust said amount.

7. The method of claim 3 further comprising responding to a spa “use level” input to adjust said amount.

8. The method of claim 1 further comprising measuring the salt level in the spa water and causing a display thereof.

9. The method of claim 8 wherein said display comprises a water care icon.

10. The method of claim 1 further comprising the step of adjusting the power supplied to the oxidizer generator apparatus to compensate for a low salt condition.

11. The method of claim 1 wherein said power is controlled by controlling the length of time it is applied.

12. A method of purifying water in a spa comprising:
providing an oxidizer generator apparatus for placement in the spa water, the oxidizer generator apparatus comprising a housing and a plurality of spaced apart electrodes positioned within the housing;
operating the oxidizer generator apparatus so as to generate one or more water purifying agents; and
adjusting the amount of purifying agent or agents generated by said oxidizer generator apparatus in response to at least one user input.

13. The method of claim 12 wherein the user input is a “spa size” input.

14. The method of claim 12 wherein the user input is a spa “use level” input.

15. The method of claim 12 wherein the user input is a “boost” input.

16. The method of claim 12 wherein the user input is a water hardness input.

17. The method of claim 12 wherein the user input further includes a spa “use level” input.

18. The method of claim 30 further comprising measuring the salt level in the spa water and causing a display thereof.

19. The method of claim 18 wherein said display comprises a water care icon.

20. The method of claim 12 further comprising the step of adjusting the amount of purifying agent or agents provided by said oxidizer generator apparatus so as to compensate for a low salt condition.
